(19) United States
(12) Patent Application Publication
(10) Pub. No.: US 2004/0044126 A1
(43) Pub. Date: Mar. 4, 2004

(54) Security system

(76) Inventor: Klaus Rohm, Walddorfhaslach (DE)

Correspondence Address: VENABLE, BAETJER, HOWARD AND CIVILETTI, LLP, P.O. BOX 34385, WASHINGTON, DC, 20043-9998, US

(21) Appl. No.: 10/343,111

(22) PCT Filed: Jul. 21, 2001
(86) PCT No.: PCT/EP01/08450

(30) Foreign Application Priority Data
Jul. 28, 2000 (DE) 10036788.7
Sep. 30, 2000 (DE) 10048548.0
Oct. 12, 2000 (DE) 10050482.5
Nov. 6, 2000 (DE) 10054734.6
Dec. 22, 2000 (DE) 20021744.5

(51) Int. Cl. C08L 1/08

(52) U.S. Cl. 525/54.3; 525/54.1

(57) ABSTRACT

The invention relates to a securing system for sealing at least one body, and/or maintaining the equilibrium state of at least one body, and/or stabilizing the position of at least one body. The invention employs at least one swelling agent that is in an operational connection with the body and can swell by absorbing substances.

The invention relates to a securing system.

Securing systems of this type serve in sealing a body, and/or maintaining the equilibrium state of a body, and/or stabilizing the position of a body.

Securing systems of this type are required in a wide variety of industrial applications. One such application is securing storage tanks. These tanks are particularly used for heating oil, and are accommodated in building basements. The storage tank is disposed in a collection chamber whose side walls are spaced from the storage tank.

If water flooding occurs, the risk exists that the water pressure will damage the pipelines leading to the storage tank, so heating oil can leak from the pipelines. It is also possible that the storage tank will float due to the buoyancy forces exerted by the influx of water, and will tip. This can cause severe damage to the tank.

In principle, storage tanks of this nature can be secured with mechanical systems. In particular, the pipelines can be sealed with seals, collars and the like. Such securing systems are structurally complex, however, and correspondingly expensive.

Moreover, mechanical securing systems can also be provided for securing the position of storage tanks. For example, the storage tanks can be screwed to the basement floor. Aside from the fact that such securing systems are structurally highly complex, the mechanical securing systems have the further disadvantage that they stipulate a modification to the construction of the seating of the storage tanks. These changes may require the storage tanks to be re-inspected by the approval authorities, which is associated with undesired high costs.

A further drawback is that bores must be drilled into the walls and floors bordering the collection chamber in order to accommodate the screws. This gives rise to the risk that leaking heating oil will penetrate the inside of the building's walling through the bores.

It is the object of the invention to create the most universal, reliable securing system possible, the system being simple and inexpensive to produce.

The features of claim 1 are provided for accomplishing this object. The dependent claims describe advantageous embodiments and modifications of the invention.

The securing system serves to secure against buoyancy, and/or seal, and/or maintain the equilibrium state, and/or fix the position of at least one body through the use of at least one swelling agent that is in an operational connection with the body and can swell by absorbing material.

To stabilize the position of a body, and/or to maintain an equilibrium state of a body, the invention capitalizes on the fact that the operational connection between the swelling agent and the body influences the forces acting on the body, especially buoyancy forces, weight and pressure forces.

The strongest influence is exerted by the swelling of the swelling agents when they come into contact with liquids or liquid-containing materials such as steam, gas and the like. The swelling is particularly effected with preset delay times.

The position of a storage tank in a collection chamber can be stabilized, for example, by the insertion of non-swollen swelling agents or slightly pre-swollen swelling agents into the space between the walls of the storage tank and the collection chamber.

When floodwater enters, the swelling agents swell considerably, thereby trapping the water, and advantageously fill the space between the walls of the storage tank and the collection chamber. In this instance, numerous operational connections exist between the storage tank forming the body and the swelling agents that help secure the storage tank.

The swelling agents provided between the walls of the storage tank and the collection chamber displace the encroaching water, which reduces the buoyancy forces acting on the storage tank. This prevents the storage tank from floating, that is, the swelling agents stabilize the tank position, so it remains in a position on the floor or a predetermined installed region, particularly a vertical position, that represents an equilibrium position.

This effect is enhanced by adhesion forces that act between the storage tank and the swelling agents resting against them, the forces likewise counteracting the buoyancy forces.

Finally, the swelling agents can also be arranged such that, when swollen, they seal any hollow spaces that may exist between the floor of the storage tank and the floor of the collection chamber. This generates suction forces that additionally secure the storage tank against floating.

Notably for sealing the floor region of heating-oil tanks, for example, other, gel-like substances can be used as additives or binders for the swelling agent.

A gel-like substance of this type can also completely replace the swelling agent in the floor region in individual types of tank systems, due to their design and the fact that they are produced on-site.

At ambient temperature, these substances have a gel-like/elastic state of aggregation, which changes into a liquid state of aggregation when the substances are heated.

These substances include paraffins, soft waxes, gel waxes, white oils (mineral-oil products), beeswax, agar, and hot glues. Other usable substances include the glue group, especially cellulose, methylcellulose, gelatins, and dextrins. Additionally, or alternatively, it is possible to use gel-like/elastic substances that result from a chemical reaction, especially caoutchouc, rubber, polymer plastics, soft PVC and polyurethanes.

It is preferable to use substances that are recyclable and environmentally friendly, such as the gel waxes and hot glues.

Furthermore, swelling agents can be used as molded bodies, possibly with mechanical devices such as belts or chains, to weigh down the storage tank. The exerted weight of the swelling agent and/or the substances to be absorbed, especially liquids such as water and fuels, can be utilized as weighting materials outside and/or inside the storage tank. The weighting process can be effected via brackets provided outside of the storage vessel, or disk-like bodies next to or beneath the tank. This also stabilizes the storage tank.

Finally, the contact of the preferably swollen swelling agent with the storage tank forming the body effects the sealing of the storage tank. In particular, the swollen swelling agent can surround and seal connections on the storage tank that connect pipelines. This can also be effected purposefully by swelling agents mounted to the pipelines. In this case, bracket- or disk-shaped bodies provided with swelling agents are advantageously used.

The swelling agents are preferably formed from super-absorbers. Such super-absorbers store considerable quantities of water. Typically, 19 of a super-absorber can store a maximum quantity of 300 g of water.

Generally, the swelling agents swell as they absorb substances, which can be gaseous, gas-containing or gel-like substances, in addition to liquids.

In the non-swollen state, the swelling agents can be present in powdered form, or another granulate, fibrous or macroporous structure. The swelling agents can be stored in casings, and form swelling bodies with them. The swelling agents can also be attached to carrier materials such as films, textiles and/or reinforced, rubber-like materials having a high frictional coefficient, such as anti-slip mats sold under the brand name “Black Cat.” Finally, the swelling agents can also be embodied as molded bodies and/or fabrics.

In addition, additives can be added to the swelling agents for purposefully changing the constitution and/or inherent behavior of the swelling agents.

In the simplest case, metered quantities of water are added to the swelling agents for pre-swelling them to preset degrees.

Alternatively or additionally, binders, especially aluminum sulfate and/or methylcellulose and/or glycol, can be added as additives to the swelling agents.

The addition of such additives purposefully alters the properties of the swelling agents. In particular, the substance absorbency, the inherent rigidity, and/or the viscosity and/or the sealing effect of the swelling agent can be influenced.

Furthermore, materials possessing predetermined mechanical, especially stabilizing, properties can be added as additives to the swelling agent. These additives include the material sold under the brand name “Black Cat,” which essentially comprises a rubber-like material and a reinforcing nylon fabric. This material can also be used as a fabric.

A feature shared by all of the embodiments of the swelling agents is that they swell from absorbing substances. To return the swollen swelling agents, at least partially, to their original, non-swollen state, return means are preferably supplied to the agents. The supply of return means can be effected in the form of an energy supply. For example, the swelling agents can be exposed to a predetermined pressure or a vacuum for drawing the substances out of the swollen swelling agents. Moreover, the swollen swelling agents can be supplied with current, heat or radiation in order to release the substances from the agents.

In addition, the return means can be formed from return substances for returning the swollen swelling agents to their initial, non-swollen state. The return substances are formed, in particular, from polyelectrolytes such as common salt or acetic acid.

The use of the return means significantly improves the ability of the swelling agents to be recycled, and reduces the energy consumption for this process.

The invention is described in detail below by way of the attached figures and exemplary embodiments. Shown are in:

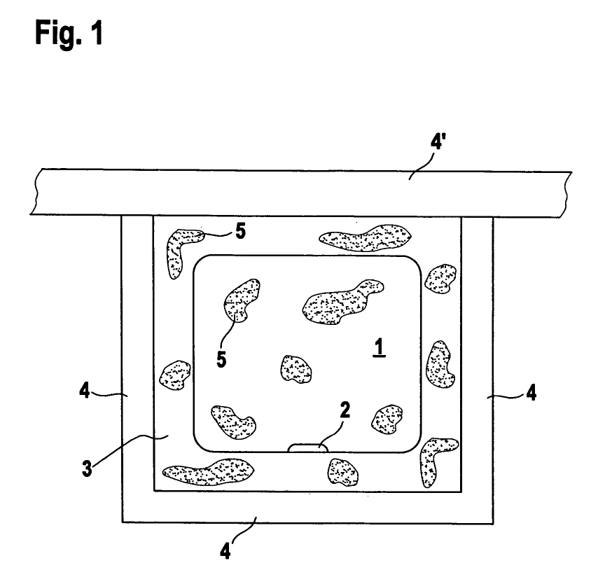

FIG. 1: a plan view of a storage tank stored in a collection chamber, with swelling agents being inserted for securing the storage tank;

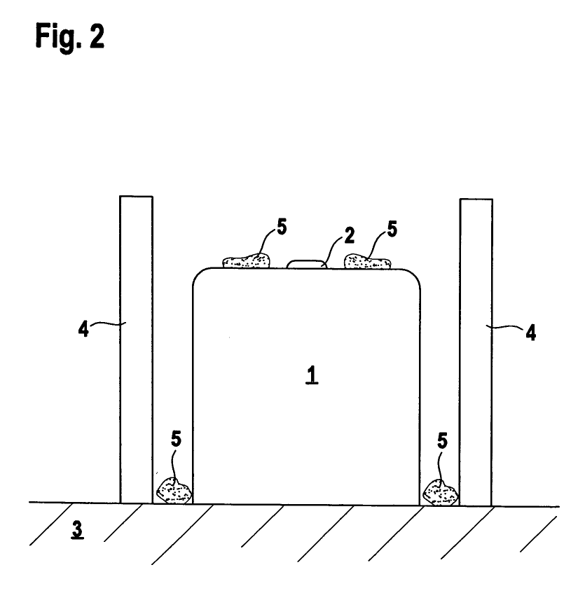

FIG. 2: a cross-section through a cutout view of the arrangement according to FIG. 1; and

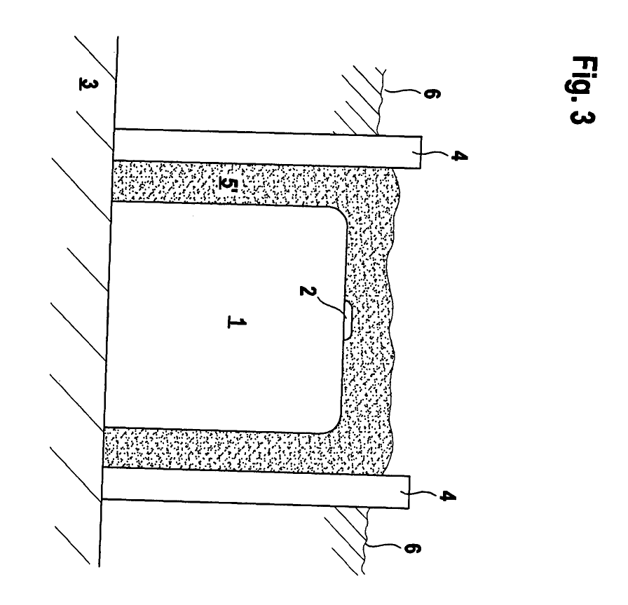

FIG. 3: the arrangement according to FIG. 2, with the swelling agents being swollen with in-flowing water.

### EXAMPLE 1

FIG. 1 schematically illustrates a storage tank 1, which is stored in a collection chamber. In the present example, heating oil is stored in the storage tank 1. The storage tank 1 has a pipe union 2 on its lid for filling with heating oil. The storage tank 1 preferably comprises plastic or steel. Pipelines, not shown, lead from the pipe union 2 to a heating system, also not shown.

The tank system embodied in this manner is preferably located in the basement of a building. The collection chamber surrounds the sides and the floor 3 of the storage tank 1, and prevents heating oil that may leak from the storage tank from flowing unimpeded throughout the basement.

The underside of the collection chamber is bordered by the basement floor 3. On the side, the collection chamber is bordered by walls 4, 4′; in the present example, one wall 4′ is formed by the building wall. At least the insides of the walls 4, 4′ and the floor 3 of the basement are covered with concrete, and are therefore impenetrable to leaking heating oil.

As can be seen particularly from FIG. 2, the walls 4, 4′ of the collection chamber, with the exception of the wall 4′ formed by the basement wall, are only slightly taller than the storage tank 1, so a person can look into the collection chamber.

In the case of flooding, water can penetrate the basement doors and windows, which are typically not watertight, and particularly flood the collection chamber. The buoyancy forces of the water can cause the storage tank 1 to float and sustain damage, so heating oil can spill out of the tank 1 uncontrollably.

Swelling bodies 5 that are formed from swelling agents are inserted into the collection chamber for securing the storage tank 1 in its position.

FIGS. 2 and 3 illustrate the principle of securing the tank position. As shown in FIG. 2, the swelling bodies 5 are distributed over the floor of the collection chamber formed by the basement floor 3, and on the lid of the storage tank 1. The swelling bodies 5 are dry, and are in their initial, non-swollen state. In the non-swollen state, the swelling bodies 5 only occupy a small portion of the space between the walls 4, 4′ of the storage tank 1 and the collection chamber.

In the case of flooding, the encroaching water particularly flows into the collection chamber, and comes into contact with the swelling bodies 5. The swelling bodies 5 bind the incoming water, and swell as their volume increases significantly; the swollen swelling bodies 5′ have a high viscosity.

With a suitable selection of the quantity of swelling bodies 5, the swollen swelling bodies 5′ fill the entire space between the walls 4, 4′ of the storage tank 1 and the collection chamber, as shown in FIG. 3. The top of the storage tank 1 is also covered with the swollen swelling bodies 5′. The level 6 of the floodwater can reach the upper edge of the collection chamber, or even higher.

The swollen swelling bodies 5′ prevent the encroaching water from flooding the collection chamber; at the very least, this greatly reduces the effect of the buoyancy forces on the storage tank 1. Adhesion forces, which counter the buoyancy forces, also act on the border surface between the walls 4, 4′ of the storage tank 1 and the swollen, viscous swelling bodies 5′.

The reduction in the buoyancy forces and the effect of the adhesion forces keep the storage tank 1 securely in its installed position, and secure it against floating.

Also, the swollen swelling bodies 5′ efficiently seal the pipe union 2 and the pipelines guided to it against the incoming water, and against possibly leaking heating oil (secondary protection).

The swelling bodies 5 essentially comprise a swelling agent or a mixture of several swelling agents. Super-absorbers used, for example, as liquid binders in diapers are used as the swelling agents. Swelling agents of this type are marketed under the brand names CABLOC, STOCKOSORB and FAVOR. Whereas, when dry, these swelling agents have a granular structure, after absorbing water they take on a viscous consistency. The length of the swelling time of the swelling bodies 5 and their viscosity in the swollen state can be preset through a suitable mixture of such swelling agents.

The swelling agents can advantageously be mixed with additives such as granulates or graphite. The capillary effect of the granulates effects a rapid, uniform distribution of the water entering the swelling body 5. The addition of graphite prevents excessive dust formation in the swelling agents in the dry state, thus reducing the risk of dust explosions.

Further additives that can be added to the swelling agents are binders such as sodium silicates, potassium silicates, multivalent metal salts such as aluminum sulfate, and glues, particularly cellulose, methylcellulose, gelatins, and substances from the glycol group.

In principle, the swelling bodies 5 can comprise swelling agents that have been pressed into plates. In an especially simple embodiment, the swelling agents 5 are present in granular or powdered form, and are sprinkled, blown, injected or poured into the collection chamber. It is also possible in principle for swelling agents 5 to flow into the collection chamber.

The swelling bodies 5 or the swelling agents are advantageously brought into the collection chamber before the entry of water, but at the latest at the same time as the water.

In the embodiment according to FIGS. 1 through 3, the swelling bodies 5 are combined into packages of specific size, and accommodated in water-permeable casings, not shown. The casings can be embodied as vessels, plate-shaped containers, carrier materials or bags. The swelling bodies 5 packaged in this manner are easy to handle, and can be installed at arbitrary locations of the collection chamber.

The casings preferably comprise expandable, elastic materials such as textile fabrics; nylon fabrics are particularly suitable. Rubber-like materials are also suited for this purpose.

With these casings, the swelling body 5 remains in the casing during the initial phase of the swelling process; as the swelling body 5 swells, the casing expands up to a limit volume. An extremely uniform swelling of the swelling bodies 5 stored in the casings occurs. If the limit volume is exceeded, the casings explode or rupture, so the swelling bodies 5′ are exposed and can freely expand as swelling continues.

As an alternative, textiles, especially wide-mesh textiles such as jute, can be used as a carrier material.

The described securing and sealing of storage tanks 1 can generally be broadened to encompass subterranean tanks, in particular. In addition, it is also generally possible to secure building parts or buildings themselves. Notably, swelling bodies can be inserted into subterranean tanks, between the compartment lid and the top of the tank, so the swollen swelling agents exert a pressure on the tank, thereby weighing it down such that the tank remains stable in its installed position.

A special variation is securing and sealing a storage tank 1 that is produced on-site and is manufactured, for example, in accordance with DIN 6625, and is typically spaced 10 cm from the floor region. The securing/sealing element is attached to the entire circumference of the jacket of the storage tank 1, and seals the tank floor against the floor surrounding the storage tank 1. Thus, the storage tank 1 is held in its installed position through the sealing effect and the prevention of buoyancy.

### EXAMPLE 2

The swelling agents can be used to position and stabilize the position of ships and boats. In this case, the swelling agents particularly permit a controlled raising of boats in dry docks, while the boat positions are simultaneously stabilized and their outside walls are sealed.

Furthermore, the swelling agents can be used to secure against buoyancy in boats, for example to prevent the sinking of boats. In this application as well, the swelling agents simultaneously seal the boat walls.

### EXAMPLE 3

The swelling agents can generally be used as sealing devices. In this instance, the agents, as molded parts, can rest in their non-swollen state against the bodies to be sealed, or in a hollow space surrounded by the body. The molded parts can be in a form-fit with the respective body. As an alternative, the swollen swelling agents form a sealing layer.

The swelling agents can particularly be used as cable seals; here, the non-swollen and/or swollen swelling agents surround the cables to be sealed. In particular, the swelling agents can be embodied as inherently stable films.

Moreover, the swelling agents can be used in the area of flood protection, in which case the swelling agents serve in at least partially sealing barriers against floodwater, or themselves form barriers against floodwater. Such barriers can particularly be constructed from stacks of sandbags or the like.

The swelling bodies that are especially suited for this type of system are those having swelling agents that are stored in large-pored casings. The casings can be jute bags, nylon stockings or the like. As soon as the non-swollen or slightly pre-swollen swelling agents come into contact with water, they swell. In the process, some of the swelling agents exit the pores to the outside, and form a viscous layer that surrounds the casing. Multiple stacks of these swelling bodies and the superposed viscous layers offer effective protection against encroaching floodwater.

These systems can also particularly be used to seal facilities that threaten the environment. Notably, the swelling agents can collect condensation water exiting the facilities.

The swelling agents can also be used to absorb or dam up substances that are harmful to the environment, especially those in aqueous solution. For example, swelling agents can be used to construct barriers for preventing oil spills on beaches. In general, the swelling agents can be used in the area of purification technology, particularly water and waste-water purification.

Moreover, such systems can be used to seal and/or protect reservoirs containing groundwater or drinking water against buoyancy. Likewise, swelling agents can be used in floodwater-retaining basins and the like as water-storage units in order to retain precipitation and floodwater.

In addition, swelling agents and possibly additional casings or carrier materials can form sealing elements.

These sealing elements can be used to close and seal canal networks, pipeline openings and the like.

In particular, in the use of swelling agents as seals, their viscous structure at the border surfaces between the bodies and the swelling agents brings about strong frictional forces or even an adhesive action, which attains a strong sealing effect in the region of the border surface.

The sealing elements can completely comprise homogeneously or heterogeneously structured swelling agents.

The sealing elements can also be used to close and seal doors and windows.

The sealing elements can particularly be used in layer technology. It is especially advantageous to use hydrophobic materials, such as horticultural fleece, as the carrier materials. The swelling agents, to which additives may be added, are fixed to the carrier material with binders and/or glues. The binders and/or glues are neutral or hydrophobic, and can be formed from adhesion glues, foam glues, methylcellulose or the like.

The sealing elements produced in accordance with layer technology can be used in unmodified form, or in further-processed form, to seal windows, doors or the like. In these instances, the carrier material can preferably be wound in different geometrical shapes. It is also possible for the sealing elements to have cushion-like embodiments.

### EXAMPLE 4

The swelling agents can advantageously be used in rescue systems, especially water-rescue systems.

An example of this is the use of swelling agents for jetties. In particular, the swelling agents can be used to produce floating bodies such as life preservers and the like.

An example of a rescue system is a diver rescue system. Here, the inside of the diving suit contains a powder comprising sodium bicarbonate and the swelling agent. In an emergency, the diver can flood his diving suit underwater, so water comes in contact with the powder. Consequently, the swelling agent swells and CO₂ gas is released due to the sodium bicarbonate dissolved in the water. This creates buoyancy forces, which move the diver to the water's surface.

### EXAMPLE 5

Various components for different applications can be produced with the swelling agents.

A first example of this is a gel-hydraulic component such as a gel-hydraulic cylinder. The swelling agent is accommodated inside the gel-hydraulic cylinder. Depending on whether water is supplied to or extracted from the swelling agent, the volume of the agent increases or decreases, thereby effecting the lifting movement.

Generally, the swelling agents serve to secure components. The swelling agents can especially be used as fillers in walls and wall elements constructed sandwich-style. In addition to the stabilizing properties, the swelling agents are sound-damping, so such walls can be used as noise-protection walls. In addition, swelling agents used in this manner can serve in storing cold or heat.

The swelling agents can also constitute parts of components, thereby absorbing radiation. Moreover, the swelling agents embodied as parts of components can aid in increasing the components' conductivity. For example, such components can be formed by rugs and wallpaper.

The swelling agents can also be used, in the form of molded bodies or fabric, as packaging parts that form filler materials. Such packaging parts can advantageously absorb liquids that leak from bottles, containers and the like housed in the package.

Finally, the swelling agents can be used to produce components that protect devices from inclement weather.

For example, the components can be embodied in the form of mats that contain swelling agents. The mats can be employed as roof seals on buildings. In this application, the mats are preferably rolled up on devices that are provided for this purpose. When inclement weather threatens, the mats are unrolled, and cover the roof tiles. In heavy rain or hail conditions, the swelling agents swell, adhere to the roof tiles and prevent them from loosening from the roof, even during severe storms. Likewise, such mats can protect glass parts, especially those in motor vehicles or winter gardens, from hail.

It is also possible to use large-surface components comprising swelling agents on external walls of buildings as flood protection.

### LIST OF REFERENCE CHARACTERS

LIST OF REFERENCE CHARACTERS

| | |
|---|---|
| (1) | Storage tank |
| (2) | Pipe union |
| (3) | Basement floor |
| (4) | Wall |
| (4′) | Wall |
| (5) | Swelling body |
| (5′) | Swelling body |
| (6) | Water level |

1. A securing system for sealing at least one body, and/or maintaining the equilibrium state of at least one body, and/or stabilizing the position of at least one body through the use of at least one swelling agent that is in an operational connection with the body and can swell by absorbing substances.

2. The securing system according to claim 1, characterized by a stationary, swimming, floating or sinking body.

3. The securing system according to claim 1 or 2, characterized in that the swelling agent swells by absorbing liquid, gel-like, gas-containing or gaseous substances, particularly with a preset delay time.

4. The securing system according to claim 3, characterized in that the substances comprise or contain water.

5. The securing system according to one of claims 1 through 4, characterized in that the swelling agents are formed by super-absorbers.

6. The securing system according to one of claims 1 through 5, characterized in that the swelling agents have a homogeneous or heterogeneous structure.

7. The securing system according to one of claims 1 through 5, characterized in that additives are added to the swelling agent and/or the substances to be absorbed.

8. The securing system according to claim 6 or 7, characterized in that the provided additives are binders from the group of multivalent metal salts, particularly aluminum sulfate, and/or substances from glue group, especially cellulose, methylcellulose or gelatins, and/or substances which, at ambient temperature, have gel-like, elastic properties and a liquid state of aggregation when heated, particularly paraffins, soft waxes or gel waxes, white oils, beeswax, agar, and/or at least partially liquid substances that can be converted into gel-like, elastic substances through chemical reactions, especially caoutchouc, rubber, polymer plastics or polyurethanes.

9. The securing system according to one of claims 1 through 8, characterized in that the swelling agent weighs down the body.

10. The securing system according to one of claims 1 through 9, characterized in that the swelling agent causes a suction force to be exerted on the body.

11. The securing system according to one of claims 1 through 10, characterized in that adhesion forces are effective between the body and the swelling agent.

12. The securing system according to one of claims 1 through 11, characterized in that static or dynamic frictional forces are effective between the body and the swelling agent.

13. The securing system according to one of claims 1 through 12, characterized in that the swelling agent has an adhesive effect that serves to connect a plurality of swelling agents and/or the swelling agent(s) with at least one body.

14. The securing system according to one of claims 1 through 13, characterized in that the swelling agent reduces the buoyancy forces acting on the body.

15. The securing system according to one of claims 1 through 14, characterized in that the body or a plurality thereof surrounds at least one space that can be at least partially filled or closed with the swelling agents in order to seal the space.

16. The securing system according to one of claims 1 through 15, characterized in that the body and the swelling agent are in a form-fit.

17. The securing system according to one of claims 1 through 16, characterized in that the swelling agent partially or completely surrounds the body.

18. The securing system according to claim 17, characterized in that the body is formed by a porous casing, in which a non-swollen or swollen swelling agent is accommodated, and when swelling occurs, a portion of the swelling agent pushes through the pores to the outside of the casing, and builds a layer there.

19. The securing system according to one of claims 1 through 17, characterized in that the swelling agents are attached to carrier materials.

20. The securing system according to one of claims 1 through 19, characterized in that the supply of return agents to the swollen swelling agents allows the substances to be at least partly separated from the swelling agents.

21. The securing system according to claim 20, characterized in that energy is supplied as the return agent to the swollen swelling agents.

22. The securing system according to claim 21, characterized in that return substances, particularly polyelectrolytes, are supplied as return agents to the swollen swelling agents.
